(19) United States
(12) Patent Application Publication
(10) Pub. No.: US 2023/0111479 A1
(43) Pub. Date: Apr. 13, 2023

(54) Fire resistant and/or retardant composition

(71) Applicant: NEXANS, Courbevoie (FR)

(72) Inventors: Thierry AUVRAY, LYON (FR); Franck GYPPAZ, LYON (FR); Guillaume GALLOT, LYON (FR)

(21) Appl. No.: 17/914,276

(22) PCT Filed: Apr. 2, 2021
(86) PCT No.: PCT/FR2021/050589

§ 371 Date: Sep. 24, 2022

(30) Foreign Application Priority Data
Apr. 6, 2020 (FR) 2003436

(51) Int. Cl. C08K 3/34; C08K 3/38; C08K 5/053; C08L 3/02; H01B 7/295

(52) U.S. Cl. CPC C08K 3/34; C08K 3/38; C08K 5/053; C08L 3/02; H01B 7/295; C08K 2201/014; C08K 2003/387; C08L 2203/202; C08L 2201/02

(57) ABSTRACT

The present invention relates to a fire resistant and/or retardant composition comprising a starch, at least one starch plasticiser, at least one first alkali silicate and at least one phyllosilicate; a method for preparing the fire resistant and/or retardant composition; a device chosen from among a power and/or telecommunications cable, and an accessory for a power and/or telecommunications cable, the cable comprising at least one fire resistant and/or retardant layer of the fire resistant and/or retardant composition, and the cable accessory comprising at least one fire resistant and/or retardant layer of the fire resistant and/or retardant composition; as well as a method for manufacturing such a device.

The present invention relates to a fire-resistant and/or fire-retardant composition comprising a starch, at least one plasticizer of the starch, at least one first alkaline silicate and at least one phyllosilicate; to a process for the preparation of said fire-resistant and/or fire-retardant composition; to a device chosen from a power and/or telecommunications cable and an accessory for a power and/or telecommunications cable, said cable comprising at least one fire-resistant and/or fire-retardant layer based on said fire-resistant and/or fire-retardant composition, and said cable accessory comprising at least one fire-resistant and/or fire-retardant layer based on said fire-resistant and/or fire-retardant composition; as well as to a process for the manufacture of such a device.

It applies typically but not exclusively to fire-retardant and/or fire-resistant compositions, in particular which can be used in electric and/or optical cables intended for the transportation of power and/or for the transmission of data, such as fire-retardant and/or fire-resistant electric and/or optical safety cables, in particular halogen-free, capable of operating for a given period of time under fire conditions without, however, being a fire propagator or a significant smoke generator; and in their accessories, such as junctions and/or terminations. These safety cables are in particular low-voltage and medium-voltage (in particular from 60 to 110 V) power transportation cables or low-frequency transmission cables, such as control or signalling cables.

The use is known, from the document WO 2016/092200 A1, in a cable or a cable accessory, and in particular in a composite layer of said cable or of said accessory, of a composite material comprising a geopolymer material and a nonwoven fibrous material. The composite layer is obtained by the application of the nonwoven fibrous material, such as a nonwoven paper tape, around a copper conductors/nonwoven fibrous material assembly, then impregnation by dipping coating of the assembly with a geopolymer composition comprising a sodium silicate, water, potassium hydroxide, a metakaolin and polypropylene fibers. However, this solution does not give complete satisfaction from the viewpoint of the process, and also from the viewpoint of the mechanical properties of the composite layer thus obtained. In particular, the impregnation stage is difficult to control and carry out, due to the sometimes too rapid hardening of the geopolymer composition during this stage. Furthermore, the composite layer thus obtained becomes hard over time, making it difficult to handle it, or to handle the cable or the accessory comprising said layer. In addition, the process of application and of drying of the composite layer is relatively long.

The purpose of the invention is consequently to overcome all or part of the abovementioned disadvantages, and to provide a composition which can be easily applied around a cable or an accessory, in particular exhibiting good mechanical properties, especially in terms of flexibility and of durability, while guaranteeing good fire resistance properties.

A first subject matter of the invention is a fire-resistant and/or fire-retardant composition, characterized in that it comprises at least one first alkaline silicate, starch, at least one plasticizer of the starch and at least one phyllosilicate, said phyllosilicate representing an amount of greater than 10% by weight, with respect to the total weight of the fire-resistant and/or fire-retardant composition.

By virtue of the fire-resistant and/or fire-retardant composition of the invention, improved mechanical properties, in particular in terms of flexibility and of durability, are obtained, while guaranteeing good fire resistance and reaction properties.

The Starch

The starch generally comprises amylose, amylopectin and optionally phytoglycogen.

By way of example (and according to the source), the starch comprises from 15% to 30% by weight of amylose, from 70% to 85% by weight approximately of amylopectin and from 0% to 20% by weight approximately of phytoglycogen, with respect to the total weight of the starch.

By way of example of starch, mention may be made of a native starch or of a modified starch, and preferably of a modified starch.

The modified starch exhibits the advantage of being generally soluble under cold conditions (i.e. soluble at a temperature of 15-35° C.). This thus makes it possible to form a cohesive structure without the need to heat the composition.

According to a preferred embodiment of the invention, the starch used in the composition is in the form of a powder.

The native starch can be a starch from cereals (e.g., wheat, corn, barley, triticale, sorghum or rice), tubers (e.g., potato or cassava), legumes (e.g., pea or soybean), roots, bulbs, stems, fruits or one of their mixtures.

The modified starch can be a physically, chemically or enzymatically modified starch.

The modified starch can be chosen from oxidized starches, starches hydrolyzed by the acidic, oxidizing or enzymatic route, starches modified (e.g. functionalized) physicochemically, such as in particular esterified and/or etherified starches.

The functionalization can be obtained by aqueous-phase acetylation with acetic anhydride, reactive extrusion of acid anhydrides, of mixed anhydrides, of fatty acid chlorides, of oligomers of caprolactones or of lactides, by sticky-phase hydroxypropylation, by dry-phase or sticky-phase cationization, by crosslinking, by anionization by phosphatation or by succinylation, by silylation, by telomerization with butadiene, and the like.

The starch is preferably chosen from esterified starches.

Mention may be made, as examples of esterified starches, of acetylated distarch adipate, which results from the esterification of the starch with acetic acid and adipic acid.

According to the invention, the starch preferably represents from 5% to 30% by weight approximately, more preferentially from 7% to 25% by weight approximately and more preferentially still from 10% to 20% by weight approximately, with respect to the total weight of said fire-resistant and/or fire-retardant composition.

The Plasticizer of the Starch

The plasticizer of the starch is intended to improve the dispersion of the starch within the fire-resistant and/or fire-retardant composition. The plasticizer exhibits the advantage of forming a gel with the starch.

The plasticizer of the starch preferably has a boiling or decomposition temperature of greater than 100° C.

It can be chosen from a metal stearate, a polyethylene glycol, ethylene glycol, a polyol, a sucrose, a plasticizer containing amide groups, a plasticizer based on modified polysaccharide(s) and one of their mixtures.

Mention may be made, as examples of sucrose, of glucose or fructose.

Mention may be made, as examples of polyols, of aliphatic polyols, such as glycerol, sorbitol, mannitol, maltitol, xylitol or an oligomer of one of these polyols.

The plasticizer is preferably a polyol, particularly preferably an aliphatic polyol and more particularly preferably glycerol.

According to the invention, the plasticizer of the starch preferably represents from 5% to 45% by weight approximately, more preferentially from 8% to 42% by weight approximately and more preferentially still from 10% to 40% by weight approximately, with respect to the total weight of said fire-resistant and/or fire-retardant composition.

According to the invention, the starch and the plasticizer of the starch (i.e. their combination) preferably represent from 15% to 80% by weight approximately, more preferentially from 20% to 65% by weight approximately and more preferentially still from 30% to 55% by weight approximately, with respect to the total weight of said fire-resistant and/or fire-retardant composition.

The plasticizer of the starch/starch ratio by weight in the fire-resistant and/or fire-retardant composition can range from 0.1 to 3 approximately.

The Phyllosilicate

The fire-resistant and/or fire-retardant composition comprises at least one phyllosilicate, the proportion of which is greater than 10% by weight approximately, with respect to the total weight of the fire-resistant and/or fire-retardant composition.

The phyllosilicate generally exhibits a lamellar sheet or tube structure.

The phyllosilicate is preferably an aluminum silicate and more preferably a potassium aluminum silicate.

The phyllosilicate is preferably a dioctahedral phyllosilicate.

The phyllosilicate can be chosen from sepiolites, palygorskites, attapulgites, kalifersites, loughlinites, falcondoites, montmorillonites, illites, talcs and micas (e.g. muscovite mica). However, it should be considered that, in the literature, palygorskite and attapulgite are often considered as being one and the same phyllosilicate.

According to a preferred embodiment of the invention, the phyllosilicate of the fire-resistant and/or fire-retardant composition is chosen from sepiolites, palygorskites, attapulgites, kalifersites, loughlinites, falcondoites, montmorillonites, illites and micas, particularly preferably from micas and more particularly preferably from micas of muscovite type.

In the fire-resistant and/or fire-retardant composition of the invention, the phyllosilicate preferably represents at least 15% by weight approximately, particularly preferably at least 20% by weight approximately and more particularly preferably at least 25% by weight approximately, with respect to the total weight of the fire-resistant and/or fire-retardant composition.

The phyllosilicate preferably represents at most 50% by weight approximately, particularly preferably at most 45% by weight approximately and more particularly preferably at most 40% by weight approximately, with respect to the total weight of the fire-resistant and/or fire-retardant composition.

The First Alkaline Silicate

The first alkaline silicate can be chosen from sodium silicates, potassium silicates and one of their mixtures. The alkaline silicates sold by Silmaco or by PQ Corporation are preferred. The first alkaline silicate is preferably a sodium silicate.

The first alkaline silicate can have a SiO₂/M₂O molar ratio ranging from 1.1 to 35 approximately, preferably from 1.3 to 10 approximately and particularly preferably from 1.4 to 5 approximately, with M being a sodium or potassium atom and preferably a sodium atom.

The fire-resistant and/or fire-retardant composition can comprise from 1% to 20% by weight approximately and preferably from 2% to 15% by weight approximately of first alkaline silicate, with respect to the total weight of the fire-resistant and/or fire-retardant composition.

The Second Alkaline Silicate

The fire-resistant and/or fire-retardant composition can additionally comprise a second alkaline silicate different from the first alkaline silicate.

By virtue of the second alkaline silicate, a fire-resistant and/or fire-retardant layer is obtained which retains a degree of flexibility during prolonged exposure to a temperature of greater than 100° C.

The second alkaline silicate can be chosen from sodium silicates, potassium silicates and one of their mixtures. The alkaline silicates sold by Silmaco or by PQ Corporation are preferred. The second alkaline silicate is preferably a sodium silicate.

The first and second alkaline silicates can respectively have SiO₂/M₂O and SiO₂/M′₂O molar ratios such that M and M′, which are identical or different, are chosen from a sodium atom and a potassium atom, and preferably a sodium atom, and said ratios have different values, preferably values such that their difference is at least 0.3, particularly preferably such that their difference is at least 0.5 and more particularly preferably such that their difference is at least 1.0.

According to an embodiment of the invention, the fire-resistant and/or fire-retardant composition comprises:
a first alkaline silicate having a SiO₂/M₂O molar ratio ranging from 1.5 to 2.6 approximately, and
a second alkaline silicate having a SiO₂/M′₂O molar ratio of greater than 2.6, preferably ranging from 2.8 to 4.5 approximately and particularly preferably ranging from 3.0 to 4.0 approximately, it being understood that M′ is identical to M.

The fire-resistant and/or fire-retardant composition can comprise from 1% to 20% by weight approximately and preferably from 2% to 15% by weight approximately of first and second alkaline silicates, with respect to the total weight of the fire-resistant and/or fire-retardant composition.

The [first alkaline silicate/second alkaline silicate] ratio by weight in the fire-resistant and/or fire-retardant composition preferably ranges from 0.5 to 2.5 and particularly preferably from 0.8 to 2.0.

The first alkaline silicate (respectively the second alkaline silicate) can be in the form of a basic aqueous solution comprising said first alkaline silicate (respectively said second alkaline silicate).

The basic aqueous solution preferably has a pH ranging from 9.5 to 12.5.

The Water

The fire-resistant and/or fire-retardant composition can comprise water.

The water preferably represents from 5% to 40% by weight approximately and preferably from 10% to 25% by weight approximately, with respect to the total weight of the fire-resistant and/or fire-retardant composition.

According to a preferred embodiment, the fire-resistant and/or fire-retardant composition does not comprise other water than that optionally used in the presence of the first alkaline silicate and optionally of the second alkaline silicate to form the abovementioned basic aqueous solution.

The Inorganic Fibers

The fire-resistant and/or fire-retardant composition can additionally comprise inorganic fibers.

The inorganic fibers preferably represent from 0.5% to 5% by weight approximately and preferably from 1.0% to 3.0% by weight approximately, with respect to the total weight of the fire-resistant and/or fire-retardant composition.

The inorganic fibers can be chosen from basalt fibers and alumina fibers.

By virtue of the inorganic fibers, a fire-resistant and/or fire-retardant layer having good integrity when exposed to a flame is obtained. Furthermore, the addition of the inorganic fibers increases the viscosity of the composition during its preparation, thus ensuring good deposition during the extrusion phase.

The Zinc Borate

The fire-resistant and/or fire-retardant composition can additionally comprise zinc borate.

The zinc borate preferably represents from 0.5% to 10% by weight approximately and preferably from 1.0% to 5% by weight approximately, with respect to the total weight of the fire-resistant and/or fire-retardant composition.

By virtue of the zinc borate, a fire-resistant and/or fire-retardant layer having an improved fire resistance is obtained. In particular, a low-temperature vitreous structure may be formed during a fire.

Additives

The fire-resistant and/or fire-retardant composition can additionally comprise one or more additives chosen from:
a dye,
an additive having a polymer structure (in powder form), chosen in particular from polyolefin fibers, such as polypropylene or polyethylene fibers (e.g. high-density polyethylene (HDPE) fibers), aramids, and technical glass fibers coated with silicone or with an organic polymer of polyethylene type; a styrene-butadiene (SBR) copolymer; a styrene-butadiene-ethylene (EBS) copolymer; all derivatives of styrene-ethylene copolymers, in particular those sold by Kraton, such as a styrene-ethylene-butylene-styrene (SEBS) copolymer, a styrene-butadiene-styrene (SBS) copolymer, a styrene-isoprene-styrene (SIS) copolymer, a styrene-propylene-ethylene (EPS) copolymer or a styrene-ethylene-propylene-styrene (SEPS) copolymer; a copolymer of ethylene and of vinyl acetate (EVA), a crosslinked polyorganosiloxane (e.g. crosslinked using a peroxide); polyethylene, optionally in powder form; lignosulfonates; cellulose acetate; other cellulose derivatives; a low-viscosity silicone oil (e.g. viscosity of the order of 12 500 cPo); and a polyethylene oil,
a compound which accelerates setting, in particular chosen from aluminum sulfate, alums (e.g. potassium aluminum double sulfate), calcium chloride, calcium sulfate, hydrated calcium sulfate, sodium aluminate, sodium carbonate, sodium chloride, sodium silicate, sodium sulfate or iron(III) chloride,
a setting retarder, in particular chosen from ammonium, alkali metals, alkaline earth metals, borax, lignosulfonates and in particular metal salts of calcium lignosulfonates, celluloses, such as carboxymethyl hydroethyl cellulose, sulfoalkylated lignins, such as, for example, sulfomethylated lignin, hydroxycarboxylic acids, copolymers of salts of 2-acrylamido methylpropanesulfonic acid and of acrylic acid or of maleic acid, and saturated salts, and
an expanded carbon material, such as an expanded graphite.

The dye is preferably a dye which is liquid at ambient temperature (i.e. at 18-25° C.).

The fire-resistant and/or fire-retardant composition can comprise from 0.01% to 15% by weight approximately of additive(s) and preferably from 0.5% to 8% by weight approximately of additive(s), with respect to the total weight of the fire-resistant and/or fire-retardant composition.

The fire-resistant and/or fire-retardant composition of the invention preferably does not employ alkaline activation of an aluminosilicate by an alkaline hydroxide and/or an alkaline silicate or reaction between the abovementioned compounds, for example to form a geopolymer, in particular by polycondensation.

In other words, the phyllosilicate and the alkaline silicate do not form together, by polycondensation, a geopolymer. The fire-resistant and/or fire-retardant composition of the invention thus does not comprise polymers of poly-sialates or poly-siloxo-sialates type.

The Fire-Resistant and/or Fire-Retardant Composition

The fire-resistant and/or fire-retardant composition of the invention is preferably in the form of a mastic or of a plastic paste, in particular by virtue of the combination of the various ingredients present in the composition.

This form of mastic or plastic paste type thus makes it possible to facilitate the handling of the composition and in particular to easily extrude it around a cable or a cable accessory.

According to one embodiment of the invention, the fire-resistant and/or fire-retardant composition has a viscosity of at least 1000 Pa·s approximately, particularly preferably of at least 2000 Pa·s approximately and more particularly preferably ranging from 3000 to 10 000 Pa·s approximately, at 25° C., and with a shear rate of at most 3000 s⁻¹.

In the present invention, the viscosity is measured using a capillary rheometer, for example at a temperature ranging from 25° C. to 80° C., and in particular with a shear rate ranging from 6 to 5000 s⁻¹, and preferably ranging from 10 to 1000 s⁻¹.

Process for the Manufacture of the Fire-Resistant and/or Fire-Retardant Composition

A second subject matter of the invention is a process for the preparation of a fire-resistant and/or fire-retardant composition as defined in the first subject matter of the invention, characterized in that it comprises at least one stage i) of mixing the starch, the plasticizer of the starch, the phyllosilicate and the first alkaline silicate.

Stage i) preferably comprises the following substages:

i0) the mixing of the constituents in liquid form, such as the plasticizer of the starch, the first alkaline silicate in solution and optionally the second alkaline silicate in solution, if it exists, to form a liquid composition,

i1) the mixing of the solid constituents, such as the phyllosilicate, the zinc borate, if it exists, and the starch, to form a solid composition,

i2) the addition of the liquid composition to a mixer of planetary mixer type,

i3) optionally, the addition of the inorganic fibers, if they exist, to the mixer,

i4) the addition of the solid composition to the mixer, to form a resulting composition, and

i5) the mixing of the resulting composition until a homogeneous paste is obtained, for example for at least 1 min and preferably for 2 to 10 min approximately.

The homogeneous paste thus obtained can then be transferred into a container.

The Device

A third subject matter of the invention is a device chosen from a power and/or telecommunications cable and an accessory for a power and/or telecommunications cable, characterized in that said cable comprises at least one fire-resistant and/or fire-retardant layer obtained from a fire-resistant and/or fire-retardant composition as defined in the first subject matter of the invention and said accessory is coated with a fire-resistant and/or fire-retardant layer obtained from a fire-resistant and/or fire-retardant composition as defined in the first subject matter of the invention.

The Cable

Advantageously, the cable in accordance with the invention complies with at least any one of the following fire performance standards: EN50200, IEC60331-1, EN50399, IEC60331-11, IEC60331-21, IEC60331-23, IEC60331-25, DIN4102, NBN713020 addendum 3, EN50577, NFC32070 CR1, IEC600332-1 and BS6387CWZ, and preferably with at least any one of the standards IEC60331-11, EN50399 and IEC60331-21.

According to an embodiment of the invention, the cable in accordance with the invention complies with the standard EN 50399 (2012/02+A1 2016), in particular with the classification criteria B2ca, s1a, d0, a1 of said standard.

The fire-resistant and/or fire-retardant layer of the cable of the invention is preferably an extruded layer.

The fire-resistant and/or fire-retardant layer preferably exhibits a substantially constant thickness and constitutes in particular a continuous protective casing.

The fire-resistant and/or fire-retardant layer preferably exhibits a thickness ranging from 0.2 to 3 mm approximately, particularly preferably from 0.5 to 1.9 mm and more particularly preferably from 0.7 to 1.2 mm approximately.

When the thickness of the fire-resistant and/or fire-retardant layer is less than 0.2 mm, the thermal protection of the cable of the invention is not sufficient.

The fire-resistant and/or fire-retardant layer of the invention is preferably nonporous.

By virtue of the presence of the fire-resistant and/or fire-retardant layer, the cable in accordance with the invention is easily and simply manufactured and exhibits good mechanical properties, in particular in terms of flexibility and of durability, while guaranteeing good fire resistance properties. In particular, the fire-resistant and/or fire-retardant layer is sufficiently flexible to make possible the handling of the cable (e.g. winding, bending, twisting) without, however, causing any prohibitive detrimental change in said layer which would have the consequence of reducing its cohesion and its fire resistance.

Furthermore, the fire-resistant and/or fire-retardant layer is transformed under the effect of a high temperature, in particular of a temperature ranging from 450° C. to 1000° C., generally reached during a fire, to form a cohesive residual layer which protects the cable and in particular the underlying layers and/or the elongated conductive element.

The fire-resistant and/or fire-retardant layer is preferably an internal layer of said cable.

According to the invention, the term “internal layer” is understood to mean a layer which does not constitute the outermost layer of the cable.

Said power and/or telecommunications cable preferentially comprises at least one elongated conductive element.

The fire-resistant and/or fire-retardant layer as defined in the invention can surround said elongated conductive element.

According to a preferred embodiment of the invention, the cable is an electric cable.

The electric cable can comprise at least one elongated electrically conductive element and at least one fire-resistant and/or fire-retardant layer as defined in the invention, said fire-resistant and/or fire-retardant layer surrounding said elongated electrically conductive element.

Preferably, the electric cable comprises a plurality of elongated electrically conductive elements and the fire-resistant and/or fire-retardant layer can then surround the plurality of elongated electrically conductive elements of the cable.

According to a particularly preferred embodiment of the invention, the elongated electrically conductive elements of the plurality of elongated electrically conductive elements are individually insulated with an electrically insulating layer, for example based on a polyolefin, which is preferably crosslinked, such as crosslinked polyethylene.

The electric cable can comprise a single fire-resistant and/or fire-retardant layer as defined in the invention or a plurality of fire-resistant and/or fire-retardant layers as defined in the invention, particularly preferably a single fire-resistant and/or fire-retardant layer and more particularly preferably a single fire-resistant and/or fire-retardant internal layer.

When the electric cable comprises a plurality of fire-resistant and/or fire-retardant layers as defined in the invention, the electric cable can comprise, according to a first alternative form, one or more elongated electrically conductive elements and the plurality of fire-resistant and/or fire-retardant layers surrounds the elongated electrically conductive element or the plurality of elongated electrically conductive elements.

By way of example, the electric cable can comprise two fire-resistant and/or fire-retardant layers as defined in the invention, said fire-resistant and/or fire-retardant layers preferably being adjacent.

When the electric cable comprises a plurality of fire-resistant and/or fire-retardant layers as defined in the invention, the electric cable can comprise, according to a second alternative form, a plurality of elongated electrically conductive elements and each of the fire-resistant and/or fire-retardant layers individually surrounds each of the elongated electrically conductive elements to form elongated insulated electrically conductive elements.

The first alternative form is preferred.

The power and/or telecommunications cable of the invention can additionally comprise an external protective sheath, which is in particular electrically insulating, surrounding the fire-resistant and/or fire-retardant layer(s).

The fire-resistant and/or fire-retardant layer can then be a layer interposed between the elongated conductive element and the external protective sheath.

The external protective sheath is preferably made of a halogen-free material. It can conventionally be made from materials which retard flame propagation or which withstand flame propagation. In particular, if these materials do not contain halogen, such sheathing is said to be of HFFR (halogen-free flame retardant) type.

The external protective sheath represents the outermost layer of the cable. It makes it possible to ensure the mechanical integrity of the cable.

It comprises at least one organic or inorganic polymer.

The choice of the organic or inorganic polymer is not limiting and these polymers are well known to a person skilled in the art.

According to a preferred embodiment of the invention, the organic or inorganic polymer is chosen from crosslinked and noncrosslinked polymers.

The organic or inorganic polymer can be a homopolymer or a copolymer having thermoplastic and/or elastomeric properties.

The inorganic polymers can be polyorganosiloxanes.

The organic polymers can be polyurethanes or polyolefins.

The polyolefins can be chosen from ethylene and propylene polymers. Mention may be made, as example of ethylene polymers, of linear low-density polyethylene (LLDPE), low-density polyethylene (LDPE), medium-density polyethylene (MDPE), high-density polyethylene (HDPE), copolymers of ethylene and of vinyl acetate (EVA), copolymers of ethylene and of butyl acrylate (EBA), of methyl acrylate (EMA) or of 2-ethylhexyl acrylate (2EHA), copolymers of ethylene and of α-olefins, such as, for example, polyethylene-octenes (PEO), copolymers of ethylene and of propylene (EPR), terpolymers of ethylene and of propylene (EPT), such as, for example, ethylene-propylene-diene monomer (EPDM) terpolymers, or one of their mixtures.

The polymer of the external protective sheath is preferably an organic polymer, more preferably an ethylene polymer and more preferably a copolymer of ethylene and of vinyl acetate, a linear low-density polyethylene or one of their mixtures.

The external protective sheath can also comprise a hydrated flame-retardant inorganic filler. This hydrated flame-retardant inorganic filler acts mainly physically by decomposing endothermically (e.g. release of water), the consequence of which is to lower the temperature of the sheath and to limit the propagation of flames along the cable. These are referred to in particular as flame-retardant properties.

The hydrated flame-retardant inorganic filler can be a metal hydroxide, such as magnesium hydroxide or aluminum trihydroxide.

The external protective sheath can additionally comprise an inert filler, in particular chosen from talc, micas, dehydrated clays and one of their mixtures.

The Cable Accessory

Advantageously, the accessory in accordance with the invention complies with at least any one of the following fire performance standards: EN50200, IEC60331-1, EN50399, IEC60331-11, IEC60331-21, IEC60331-23, IEC60331-25, DIN4102, NBN713020 addendum 3, EN50577, NFC32070 CR1, IEC600332-1 and BS6387CWZ, and preferably with at least any one of the standards IEC60331-11, EN50399 and IEC60331-21.

According to an embodiment of the invention, the accessory in accordance with the invention complies with the standard EN 50399 (2012/02+A1 2016), in particular with the classification criteria B2ca, s1a, d0, a1 of said standard.

The fire-resistant and/or fire-retardant layer of the accessory is preferably an extruded layer.

The fire-resistant and/or fire-retardant layer preferably exhibits a substantially constant thickness and constitutes in particular a continuous protective casing.

The fire-resistant and/or fire-retardant layer preferably exhibits a thickness ranging from 0.2 to 3 mm approximately, particularly preferably from 0.5 to 1.9 mm and more particularly preferably from 0.7 to 1.2 mm approximately.

When the thickness of the fire-resistant and/or fire-retardant layer is less than 0.2 mm, the thermal protection of the accessory of the invention is not sufficient.

The fire-resistant and/or fire-retardant layer is preferably nonporous.

By virtue of the presence of the fire-resistant and/or fire-retardant layer, the accessory in accordance with the invention is easily and simply manufactured and exhibits good mechanical properties, in particular in terms of flexibility and of durability, while guaranteeing good fire resistance properties. In particular, the fire-resistant and/or fire-retardant layer is sufficiently flexible to make possible the handling of the accessory (e.g. winding, bending, twisting) without, however, causing any prohibitive detrimental change in said layer which would have the consequence of reducing its cohesion and its fire resistance.

Furthermore, the fire-resistant and/or fire-retardant layer is transformed under the effect of a high temperature, in particular of a temperature ranging from 450° C. to 1000° C., generally reached during a fire, to form a cohesive residual layer which protects the cable accessory and in particular the underlying layers and/or the elongated conductive element.

A cable accessory can be a power cabinet, a junction or a termination, and preferably a junction or a power cabinet.

The fire-resistant and/or fire-retardant layer acts as electrical, mechanical and thermal protection for the electric cable accessory. It can surround said accessory at least partially and preferably completely.

It is preferably a layer independent of the accessory. In other words, it can be separated from the cable accessory without causing the slightest mechanical and/or electrical damage to said cable accessory and in particular without causing the slightest damage to the outermost layer of the cable accessory.

In other words, the fire-resistant and/or fire-retardant layer preferably does not form an integral part of the cable accessory as is, thus making it possible to preserve the electrical and/or mechanical integrity of the cable accessory. More particularly, the electrical and mechanical properties of the cable accessory with which the layer is combined remain intact.

The fire-resistant and/or fire-retardant layer can surround the outermost element of the accessory or the outermost layer of the accessory.

The fire-resistant and/or fire-retardant layer is preferably in direct physical contact with the accessory and in particular with the outermost element or the outermost layer of the accessory.

The electric cable accessory is preferably intended to surround at least a part or end of an electric cable.

The accessory preferably comprises at least one semiconductor element and at least one electrically insulating element.

The semiconductor element is well known for controlling the geometry of the electric field when the electric cable, intended to be combined with said accessory, is under voltage.

The accessory can typically be a hollow longitudinal body, such as, for example, an electric cable junction. The junction makes it possible in particular to connect together two electric cables, the junction being intended to surround at least a part or end of these two electric cables.

According to a particularly preferred embodiment of the invention, the accessory is an electric cable junction comprising:
a first semiconductor element, in particular surrounding a part or end of the two electric cables,
an electrically insulating element, in particular surrounding the first semiconductor element and a part or end of the two electric cables, and
a second semiconductor element, in particular surrounding a part or end of the two electric cables.

The first semiconductor element and the second semiconductor element are preferably separated by the electrically insulating element.

The junction can additionally comprise one or more filler layers surrounding the second semiconductor element.

The junction can additionally comprise a third semiconductor element, in particular surrounding the electrically insulating element.

The junction can additionally comprise a layer of a self-amalgamating material surrounding the third semiconductor element, said layer of a self-amalgamating material preferentially being surrounded by a copper knit, in particular fixed to said layer by means of a polyvinyl chloride (PVC) tape.

In this embodiment, the fire-resistant and/or fire-retardant layer can surround the second semiconductor element of the junction which is the outermost element of the accessory.

A fourth subject matter of the invention is a process for the manufacture of a device as defined according to the third subject matter of the invention, characterized in that it comprises at least the following stages:

1) the preparation of a fire-resistant and/or fire-retardant composition according to a process as defined in the second subject matter of the invention; and

2) the extrusion of the fire-resistant and/or fire-retardant composition prepared in stage 1):
either around one or more elongated conductive elements and/or around an internal layer of a power and/or telecommunications cable,
or around an accessory, such as a junction or a termination.

The process in accordance with the invention is rapid and simple. It makes it possible to manufacture in few stages a cable or an accessory exhibiting good mechanical properties, in particular in terms of flexibility and of durability, while guaranteeing good fire resistance.

The extrusion can be carried out at ambient temperature or under hot conditions, in particular at a temperature ranging from 20° C. to 95° C. approximately and preferably from 35° C. to 75° C. approximately.

According to a specific embodiment of the invention and when a power and/or telecommunications cable is manufactured, the process can additionally comprise, before, during or after stage 2), a stage 3) of application of an external protective sheath as defined in the first subject matter of the invention, which is in particular electrically insulating, around the fire-resistant and/or fire-retardant layer.

This external protective sheath can in particular be produced by extrusion or coextrusion.

Stage 3) is generally carried out at a temperature ranging from 145° C. to 220° C. approximately.

### BRIEF DESCRIPTION OF THE DRAWINGS

FIG. 1 represents a diagrammatic view of an electric cable according to an embodiment of the present invention.

For reasons of clarity, only the components essential for the understanding of the invention have been represented diagrammatically in these FIGURES, this being done without observing a scale.

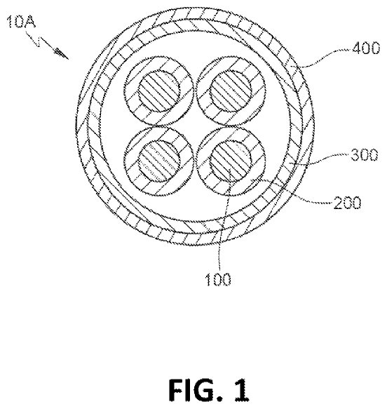

The electric cable 10A, illustrated in FIG. 1, corresponds to a fire-resistant electric cable of K25 or RZ1K type.

This electric cable 10A comprises four elongated electrically conductive elements 100, each being insulated with an electrically insulating layer 200, and, successively and coaxially around these four elongated insulated electrically conductive elements (100, 200), a fire-resistant and/or fire-retardant layer 300 as defined in the invention surrounding the four elongated insulated electrically conductive elements (100, 200) and an external sheath 400 of HFFR type surrounding the fire-resistant and/or fire-retardant layer 300. The fire-resistant and/or fire-retardant layer 300 is as defined in the invention and is advantageously provided in the form of an extruded layer.

The following examples make it possible to illustrate the present invention. They do not have a limiting nature with regard to the overall scope of the invention as presented in the claims.

### EXAMPLES

The starting materials used in the examples are listed below:
approximately 50% by weight aqueous solution of a first sodium silicate of “water glass” type, from Simalco, sodium silicate with a SiO₂/Na₂O molar ratio of approximately 2.0,
approximately 38% by weight aqueous solution of a second sodium silicate of “water glass” type, from Simalco, sodium silicate with a SiO₂/Na₂O molar ratio of approximately 3.4,
glycerol, Roquette Freres, Reference 8400,
mica, Imerys, Mica MKT,
modified starch, Roquette Freres, Pregeflo CH40,
basalt fibers, Basaltex, product: BCS17-12.7-KV05/1,
zinc borate, Borax, Firebreak ZB.

Unless indicated otherwise, all these starting materials were used as received from the manufacturers.

### Example 1: Preparation of a Fire-Resistant Cable in Accordance with the Invention

A fire-resistant and/or fire-retardant composition was prepared in the following way: 4000 g of an 84% by weight solution of glycerol in water were mixed with 1000 g of a 50% by weight aqueous solution of a first sodium silicate and 1000 g of a 38% by weight aqueous solution of a second sodium silicate, to form a liquid composition.

Separately, 4800 g of mica, 2000 g of modified starch and 400 g of zinc borate were mixed to form a solid composition.

The liquid composition was added to a planetary mixer, followed by 200 g of basalt fibers, then followed by the solid composition, to form a resulting composition.

The resulting composition was mixed in the mixer for 3 minutes until said fire-resistant and/or fire-retardant composition was obtained in the form of a homogeneous paste.

The fire-resistant and/or fire-retardant composition thus obtained was extruded around a cable comprising 5 copper conductors with a section of 1.5 mm², each of the conductors being surrounded with an electrically insulating layer based on XLPE. On conclusion of the stage of extrusion around the cable, a fire-resistant and/or fire-retardant layer surrounding the insulated conductors is obtained.

The fire-resistant and/or fire-retardant layer formed has a thickness of 0.7 mm.

The assembly obtained is subsequently covered by hot extrusion with a protective polymer sheath based on an HFFR mixture produced by Nexans based on polyethylene and on flame-retardant fillers, said sheath having a thickness of approximately 1.54 mm. A cable 10A in accordance with the invention was thus obtained. The flame performance qualities of the cable 10A are determined according to the standard EN50399. 15 cable sections positioned on a vertical ladder are exposed to a flame with a power of 20 kW for 20 min. A comparative cable 2, identical to the cable 10A except that it does not comprise a fire-resistant and/or fire-retardant layer and that its sheath has a thickness of 1.42 mm, was also tested under the same conditions.

The results are given in table 1 below:

TABLE 1

| Parameters | Cable 10A | Cable 2, comparative |
|---|---|---|
| pHRR (kW) | 23.0 | 661.8 |
| Time to the pHRR (s) | 792.0 | 876.0 |
| THR (MJ) | 11.8 | 110.9 |
| SPR (m²/s) | 0.0 | 0.7 |
| TSP (m²) | 8.0 | 149.6 |
| Class according to EN 50399 | B2 s1 d0 | E/F s2 d2 |

In this table, the acronym HRR corresponds to the expression “Heat Release Rate”, which provides information on the heat release rate, the acronym THR corresponds to the expression “Total Heat Release”, which provides information on the amount of heat released during the combustion, the acronym SPR corresponds to the expression “Smoke Production Rate”, which provides information on the smoke production rate, and the acronym TSP corresponds to the expression “Total Smoke Production”, which provides information on the total amount of smoke produced.

These results demonstrate that the cable 10A in accordance with the invention, unlike the comparative cable 2 not forming part of the invention, exhibits the maximum fire protection properties from the viewpoint of the requirements of the European standard EN 50399.

1. A fire-resistant and/or fire-retardant composition comprising:
at least one first alkaline silicate,
starch,
at least one plasticizer of the starch, and
at least one phyllosilicate, said phyllosilicate representing an amount of greater than 10% by weight with respect to the total weight of the fire-resistant and/or fire-retardant composition.

2. The fire-resistant and/or fire-retardant composition as claimed in claim 1, wherein the plasticizer of the starch is chosen from aliphatic polyols.

3. The fire-resistant and/or fire-retardant composition as claimed in claim 1, wherein the starch and the plasticizer of the starch represent from 15% to 80% by weight with respect to the total weight of said fire-resistant and/or fire-retardant composition layer.

4. The fire-resistant and/or fire-retardant composition as claimed in claim 1, wherein the phyllosilicate is chosen selected from the group consisting of sepiolites, palygorskites, attapulgites, kalifersites, loughlinites, falcondoites, montmorillonites, illites, talcs, and micas.

5. The fire-resistant and/or fire-retardant composition as claimed in claim 1, wherein the phyllosilicate represents at least 20% by weight with respect to the total weight of the fire-resistant and/or fire-retardant composition.

6. The fire-resistant and/or fire-retardant composition as claimed in claim 1, wherein the phyllosilicate represents at most 50% by weight with respect to the total weight of the fire-resistant and/or fire-retardant composition.

7. The fire-resistant and/or fire-retardant composition as claimed in claim 1, wherein said fire-resistant and/or fire-retardant composition additionally comprises a second alkaline silicate different from the first alkaline silicate.

8. The fire-resistant and/or fire-retardant composition as claimed in claim 1, wherein said fire-resistant and/or fire-retardant composition comprises:
a first alkaline silicate having a SiO₂/M₂O molar ratio ranging from 1.5 to 2.6, and
a second alkaline silicate having a SiO₂/M′₂O molar ratio of greater than 2.6, it being understood that M′ is identical to M, and M and M′ are chosen from a sodium atom and a potassium atom.

9. The fire-resistant and/or fire-retardant composition as claimed in claim 7, wherein said fire-resistant and/or fire-retardant composition comprises from 1% to 20% by weight of first and second alkaline silicates, with respect to the total weight of the fire-resistant and/or fire-retardant composition.

10. The fire-resistant and/or fire-retardant composition as claimed in claim 1, wherein said fire-resistant and/or fire-retardant additionally comprises inorganic fibers.

11. The fire-resistant and/or fire-retardant composition as claimed in claim 1, wherein said fire-resistant and/or fire-retardant composition additionally comprises zinc borate.

12. The fire-resistant and/or fire-retardant composition as claimed in claim 1, wherein said fire-resistant and/or fire-retardant composition has a viscosity of at least 1000 Pa·s, at 25° C., and with a shear rate of at most 3000 s⁻¹.

13. A process for the preparation of the fire-resistant and/or fire-retardant composition as defined in claim 1, wherein said fire-resistant and/or fire-retardant composition comprises at least one stage i) of mixing the starch, the plasticizer of the starch, the phyllosilicate and the first alkaline silicate.

14. A device chosen from a power and/or telecommunications cable and an accessory for a power and/or telecommunications cable, wherein said cable comprises at least one fire-resistant and/or fire-retardant layer, and said cable accessory is coated with a fire-resistant and/or fire-retardant layer, each obtained from a fire-resistant and/or fire-retardant composition as defined in claim 1.

15. The process for the manufacture of the device as claimed in claim 14, wherein said process comprises at least the following stages:
1) the preparation of fire-resistant and/or fire-retardant composition includes at least one stage i) of mixing the starch, the plasticizer of the starch, the phyllosilicate and the first alkaline silicate; and
2) the extrusion of the fire-resistant and/or fire-retardant composition prepared in stage 1):
either around one or more elongated conductive elements and/or around an internal layer of a power and/or telecommunications cable,
or around a cable accessory.
